(19) United States
(12) Patent Application Publication
(10) Pub. No.: US 2025/0363451 A1
(43) Pub. Date: Nov. 27, 2025

(54) SYSTEM AND METHOD FOR PLANNING AND COORDINATION OF SPARE PARTS FOR AGRICULTURAL MACHINES

(71) Applicant: CLAAS Omaha Inc., Omaha, NE (US)

(72) Inventors: Reinhard Hesse, Versmold (DE); Patricio Frangella, Columbus, IN (US); Jordan Hellbusch, Omaha, NE (US); Ray Ochsner, Papillion, NE (US); Jeff Tilden, Columbus, IN (US); Mark Turnis, Treynor, IA (US); Scott Wellensiek, Harsewinkel (DE); Christoph Tetzlaff, Omaha, NE (US); Robin Monkenbusch, Rheda-Wiedenbrück (DE); Adam Lee Haworth, Louisville, NE (US)

(73) Assignee: CLAAS Omaha Inc., Omaha, NE (US)

(21) Appl. No.: 19/294,183

(22) Filed: Aug. 7, 2025

Related U.S. Application Data
(63) Continuation of application No. PCT/IB2023/061308, filed on Nov. 9, 2023.

(30) Foreign Application Priority Data
Feb. 9, 2023 (DE) 10 2023 103 208.9

(51) Int. Cl. G06Q 10/087; G06Q 10/083; G06Q 50/02

(52) U.S. Cl. CPC G06Q 10/08726; G06Q 10/08355; G06Q 50/02

(57) ABSTRACT

A spare parts planning system and method for planning and coordinating spare parts for agricultural machines. The spare parts planning system may be configured to perform planning and coordination of spare parts for a service order, with the service order being derived from the definition of a customer problem. The spare parts planning system may additionally be configured to assemble the spare parts stock stored in the respective warehouse in such a way that the spare parts stock is adapted to the expected parts failure probability, with this adaptation comprising the storage of the spare parts and/or the procurement of the spare parts from central warehouses.

### CROSS REFERENCE TO RELATED APPLICATIONS

This application is a continuation-in-part and claims priority to PCT Application No. PCT/IB2023/061308 (published as WO/2024/165907) filed on Nov. 9, 2023, which claims priority to German Patent Application No. 10 2023 103 208.9 filed Feb. 9, 2023, the entire disclosure of both which are hereby incorporated by reference herein. This application is also related to U.S. application Ser. No. ______ (attorney docket no. 15191-24025A (P05768/8)), U.S. application Ser. No. ______ (attorney docket no. 15191-24026A (P05769/8)), U.S. application Ser. No. ______ (attorney docket no. 15191-24027A (P05770/8)), U.S. application Ser. No. ______ (attorney docket no. 15191-24028A (P05771/8)), U.S. application Ser. No. ______ (attorney docket no. 15191-24029A (P05772/8)), U.S. application Ser. No. ______ (attorney docket no. 15191-24031A (P05774/8)), and U.S. application Ser. No. ______ (attorney docket no. 15191-24032A (P05775/8)), each of which are incorporated by reference herein in their entirety.

### TECHNICAL FIELD

The present invention relates to a spare parts planning system for planning and coordinating spare parts for agricultural machines.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Agricultural machines may form agricultural working machines for work-related use on agricultural fields and regularly may require technical services, including repairs of worn or damaged components using spare parts. EP 4 024 320 A1 discloses a method for planning work in a warehouse. It is often a problem with simple warehouses that there is insufficient stock of spare parts, resulting in downtimes that are very disadvantageous for the farmer since technical problems of agricultural machines often occur during use in the agricultural field. Such downtime is very negative for the farmer, as it leads to reduced productivity, loss of revenue and higher operating costs.

### BRIEF DESCRIPTION OF THE DRAWING

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates an example spare parts planning system for storage and delivery of spare parts for agricultural machines in order to plan and coordinate repairs and/or maintenance of these agricultural machines of the customer.

### DETAILED DESCRIPTION

As discussed in the background, EP 4 024 320 A1 discloses a method for planning work in a warehouse. It may often be a problem with warehouses that there is insufficient stock of spare parts, resulting in downtimes that are very disadvantageous for the farmer since technical problems of agricultural machines often occur when the agricultural machines are most needed in the agricultural field. Such downtime very negatively impacts the farmer, as it leads to reduced productivity, loss of revenue and higher operating costs.

Thus, in one aspect, downtimes of agricultural machines may be reduced or minimized for more efficient and profitable agricultural operations for the respective customer, whereby there may always be a sufficient supply of agricultural machines spare parts in the warehouses.

In one or some embodiments, the spare parts may be stored in one or more warehouses, such as in central warehouse(s) and local warehouse(s) (where the local warehouse(s) are defined as being closer to the respective farm and/or being closer to the respective agricultural machine subject to service). Complicating matters is balancing the need for appropriate stocking (e.g., the current and/or future stock) the both of central warehouse(s) and local warehouse(s). As discussed further below, the appropriate stocking may depend on a variety of factors, which may result in the various local warehouses having different stocks of spare parts. In this regard, the dynamic and automatic stocking of the local warehouses may be tailored to the specific needs of the respective farm(s) proximate thereto, as discussed further below.

Thus, in one or some embodiments, the spare parts planning system is configured (such as trained and/or programmed) to perform automatic planning and automatic coordination of spare parts directed towards or responsive to a respective service order. The respective service order may be derived from the definition of a customer problem, with the spare parts planning system automatically assembling the respective spare parts stock stored in the respective warehouse in such a way that the respective spare parts stock is adapted or modified to the expected parts failure probability (e.g., based on automatic expected parts failure probability). As one example, the current stock in the respective warehouse and/or in the central warehouse may be accessed or determined along with the expected probability of failure (along with the estimated determination as to the expected time of failure) in order to determine whether and/or when to automatically transport the spare part to the respective warehouse from the respective central warehouse. In particular, the adaptation may comprise the storage of the spare parts in a central warehouse (e.g., automatic storage via robots or the like) and/or the procurement of the spare parts (e.g., automatic procurement) from the central warehouse and/or the delivery of the spare parts from the central warehouse (e.g., automatic delivery, such as via automatic operating drones). The spare parts may comprise any one, any combination, or all of: maintenance parts; wear parts; or repair parts. In one or some embodiments, the expected parts failure probability may be related to the problems predominantly occurring in the respective region. In this regard, for a respective customer problem, which may relate to a respective agricultural production machine, the spare parts planning system may automatically determine the respective agricultural production machine based on the respective customer problem, automatically correlate for the respective agricultural production machine, the problems predominantly occurring in the respective region, automatically determine the expected parts failure probability for the problems predominantly occurring in the respective region, and automatically procure and/or automatically store and/or automatically transport the spare part(s) accordingly.

The respective warehouse may comprise a spare parts warehouse that includes a specific or designated area so that faster or the fastest possible delivery of the required spare parts is ensured. In one or some embodiments, the warehouse may supply customers with the correct and/or suitable spare parts 24 hours a day, 365 days a year. This may mean that spare parts orders, from receipt to dispatch, are processed even on weekends and at any time of the day or night. Compared to a warehouse, a central warehouse may store a larger quantity of spare parts.

In this regard, possible downtime of the agricultural machine may be reduced due to the spare parts stock stored in the respective warehouse, so that the maintenance of an efficient and profitable agricultural operation may be actively ensured.

In one or some embodiments, the spare parts planning system is configured to automatically determine the expected parts failure probability depending on any one, any combination, or all of: seasonal probability requirements; information regarding the agricultural machine; or location information. The probability of failure of certain parts may thus depend on any one, any combination, or all of: the season; the type of the agricultural machine; the age of the agricultural machine; the location of the agricultural machine; or the type of use of the agricultural machine. In this regard, the spare parts planning system may automatically and dynamically update the expected parts failure probability responsive to different inputs. Various different inputs are contemplated, responsive to which the spare parts planning system may automatically and dynamically respond (e.g., responsive to different seasons (such as automatically determined by the spare parts planning system), responsive to changes in location of the agricultural machine (such as automatically performed based automatic input from a GPS receiver associated with or on the agricultural machine being automatically input to the spare parts planning system), responsive to changes in use of the agricultural machine (such as automatically performed based on automatic input from the agricultural machine to the spare parts planning system), responsive to determining a different type of agricultural machine is being used (such as the spare parts planning system automatically receiving input as to a new or different agricultural machine being used)).

In one or some embodiments, the agricultural machine comprises a self-propelled combine harvester or a self-propelled forage harvester. Furthermore, the agricultural machine may be a tractor, such as with at least one implement or without an implement. The customer who owns the agricultural machine may be a farmer who, for example, is inside the agricultural machine, such as inside a driver's cab of the agricultural machine, or outside the agricultural machine during the reporting of the customer's problem.

Various spare parts are contemplated. For example, the spare parts may comprise any one, any combination, or all of: maintenance parts; or wear parts and/or repair parts of any one, any combination, or all of the self-propelled combine harvester, self-propelled forage harvester, tractor, or implements of these agricultural machines.

In one or some embodiments, the spare parts planning system is configured to automatically optimize the quantity of stored spare parts and/or the procurement of the spare parts depending on the automatically determined expected probability of parts failure, such as to optimize in such a way that the spare parts may reach (such as always reach) each customer quickly, such as quickest. This may reduce adverse downtime of the agricultural machines to ensure efficient and profitable farming operations for each customer.

In one or some embodiments, the customer problem has, in addition to information regarding a spare part, a delivery position, delivery destination, or delivery location of this spare part as desired by the customer. This may enable the customer to optimally adapt the delivery location of the spare part in advance.

In one or some embodiments, the delivery location of the spare part desired on the part of the customer may be a self-pickup location, such as at the warehouse where the spare part is stored. In other words, the spare part may be delivered to the desired position or the specified location, and the customer may collect this spare part himself or herself from the specified location. This may have the advantage that the farmer's farming operation is not disturbed if, while the farmer is using the agricultural machine, he or she realizes that a spare part will soon be required, but nevertheless the current agricultural use of the agricultural machine may be performed without any problems. Thus, the farmer may pick up the spare part after using the agricultural machine and then may use it in the agricultural machine and/or have it used by an agricultural machine technician.

In one or some embodiments, a delivery position of a spare part desired by the customer may be a drop-off position. The spare part may be handed over to the customer at the drop-off position. This may have the advantage that the farmer may save additional travel time and, in the event of an unavoidable repair that must be performed during agricultural use of the agricultural machine, the agricultural machine may still be repaired as quickly as possible. Further, the drop-off position may be programmed, such as automatically programmed into an automated delivery vehicle, such as an automated self-driving truck or drone, so that the spare part is dropped off at the drop-off position.

In one or some embodiments, the spare parts planning system is configured to automatically generate a route plan, such as an optimal route plan, for the coordination of the spare parts for a spare parts carrier and/or a spare parts supplier starting from the central warehouse and/or the warehouse to an optimal delivery position for the customer. This may further ensure and optimize the fast delivery of the appropriate spare parts.

In one or some embodiments, the spare parts planning system is configured to include existing or upcoming events when automatically determining the route plan, such as the optimal route plan. Such events may be, for example, road closures due to accidents. The optimal route plan may automatically avoid such road closures in advance in order to continue to optimally plan delivery in terms of time, so that the maintenance of the customer's efficient and profitable agricultural operation continues to be optimally ensured despite such a road closure.

In one or some embodiments, the spare parts planning system is configured to automatically determine the required time period for storing (such as automatically storing via robots or the like) the spare parts and/or for procuring (such as automatically procuring via automatic ordering and/or automatic delivery via drones or self-driving trucks) the spare parts from central warehouses and/or for reaching (such as automatically reaching via automatic delivery via drones or self-driving trucks) the desired delivery position of the spare part.

In one or some embodiments, the spare parts planning system is configured so that the customer problem additionally may have a predefined delivery time for the delivery (such as the automated delivery) of the spare part at the predefined delivery position. The delivery time and/or the delivery position may be predefined by the customer.

In one or some embodiments, the spare parts planning system is configured so that the shortest feasible time period for the delivery of the spare part to the predetermined delivery position may be set for the customer using a fee payment, such as using a digital fee payment.

In one or some embodiments, the spare parts planning system is configured to automatically determine the expected parts failure probability in an automatic and dynamic predictive manner, such as with regard to time (e.g., a defined future point in time), and thus to optimize the storage of the spare parts and/or the procurement of the spare parts from central warehouses and/or the delivery of the spare parts to the delivery position for all customers.

In one or some embodiments, the spare parts planning system is configured to enable the operator of the spare parts planning system and/or the customer to track the spare parts, such as satellite-based position and/or route tracking. This may enable the operator of the spare parts planning system and/or the customer to clearly and unambiguously record where the spare part is located. In particular, the tracking of the spare parts may be automatic so that the dynamic tracking of the location of the spare parts, and the notifications to the customer may be automatically pushed.

In one or some embodiments, the spare parts planning system is configured to automatically prepare the spare parts stock stored in the respective warehouse in advance for repairs and/or maintenance of agricultural machines depending on the service order in such a way that the required spare parts and/or tools for the repair and/or maintenance of the agricultural machine are available at the customer's site at the latest at the same time as the assigned agricultural machine technician. This may optimize the on-site deployment of the agricultural machine technicians in terms of time, as they do not have to wait for the required spare parts and/or tools. This may further improve the time planning of both the customer and the agricultural machine technicians.

In one or some embodiments, the spare parts planning system includes at least one computer-based server, at least one computer-readable database, and one or more communication device (e.g., a tablet, a smartphone, a computer, with wired and/or wireless communication capability via one or more networks, such as wireless networks and/or the Internet). In this regard, the at least one server, the at least one database and the one or more communication device may communicate (e.g., wired and/or wireless communication links) with one another via one or more communication networks. An example of a communication device is from a customer, which may transmit a customer problem regarding the repair and/or maintenance of an agricultural machine of the customer. In one or some embodiments, the communication device may each be configured to automatically determine their respective position coordinates (e.g., a GPS receiver may be included in the communication device in order to communicate with one or more satellites in order to generate the current location or current position coordinates of the communication device) and automatically transmit these determined position coordinates to the server and/or the database of the spare parts planning system. The server may be configured to automatically determine the deployment planning of the spare parts suppliers and/or agricultural machine technicians directed towards the service order and, based thereon, to automatically coordinate the delivery of the spare parts as well as the repair and/or maintenance of the customer's agricultural machines, so that the required spare parts and/or tools are available at the customer's place of use at the latest at the same time as the commissioned agricultural machine technician. The server of the spare parts planning system may automatically perform all necessary planning and coordination, so that, for example, communication resources may be relieved in terms of computing.

In one or some embodiments, the distances of the spare parts suppliers and/or the agricultural machine technicians and/or the spare parts to the customer-specific place of use may be determined using satellite-based position information from communication device of the agricultural machine technicians and/or the customer.

In one or some embodiments, the means of communication of the spare parts suppliers and/or the agricultural machine technicians and/or the customer may be mobile phones, tablets and/or computer systems, such as mobile computer systems. Alternatively or additionally, a suitable means of communication may be arranged or positioned in the agricultural machine, such as in the driver's cab of the agricultural machine, whose position may be attributable to the customer.

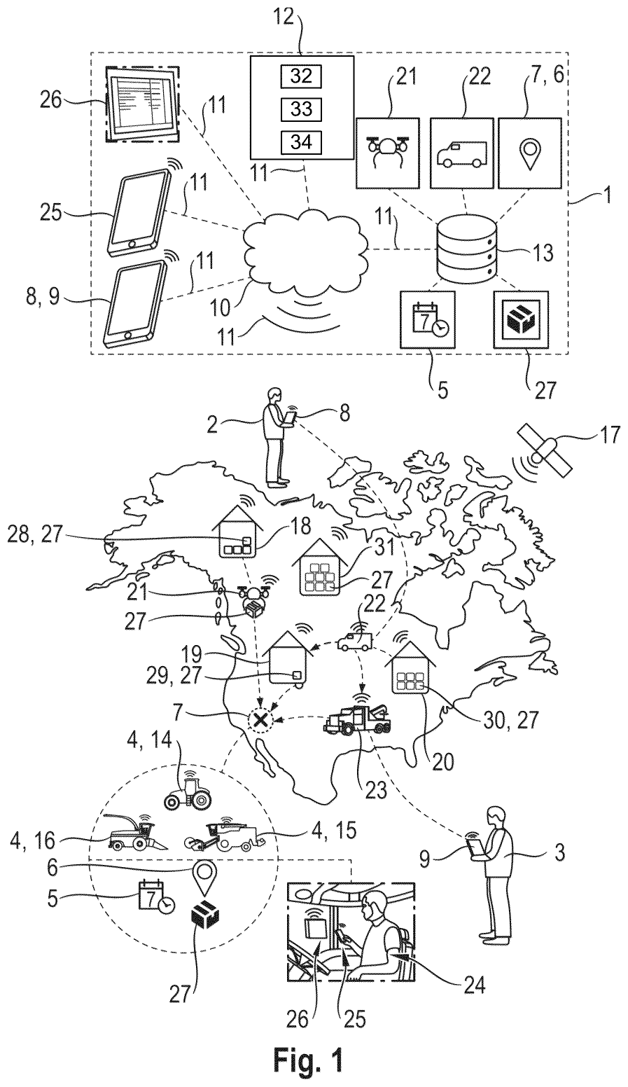

Referring to the FIGURE, FIG. 1 illustrates the spare parts planning system 1 for improved or optimal storage and delivery of spare parts 27 for agricultural machines 4 in order to automatically plan and coordinate repairs and/or maintenance of these agricultural machines 4 of the customer 24, who is a farmer. Such an agricultural machine 4 of the customer 24 may be a self-propelled combine harvester 15, a self-propelled forage harvester 16 or a tractor 14. The spare parts planning system 1 may automatically assemble the spare parts stock 28, 29, 30 stored in the respective warehouse 18, 19, 20, whereby these spare parts stocks 28, 29, 30 may be automatically adapted or configured in advance with regard to the regionally expected part failure probabilities in such a way that the efficiency and/or the profitability of the agricultural operation of the customer 24 may be actively secured.

The spare parts planning system 1 may comprise, in addition to the communication device(s) 8, 9, 25, 26, at least one server (e.g., a server 12), and at least one database (e.g., database 13). The server 12 may comprise a hardware server and/or computer-based server, wherein the database 13 may be formed as an internal electronic memory of the server 12 and/or as an external electronic memory outside the server 12. The server 12 may be formed separately as well as spaced apart from the communication device 8, 9, 25, 26.

The communication device 8, 9, 25, 26 may each be configured to automatically determine their respective position coordinates by means of satellites 17 and to transmit these determined position coordinates to the server 12 and/or the database 13 of the spare parts planning system 1.

The server 12 may comprise computing and communication functionality, and may include at least one processor 32, at least one memory 33, and at least one communication interface 34. The at least one processor 32 and at least one memory 33 may be in communication (e.g., wired and/or wirelessly) with one another. In one or some embodiments, the processor 32 may comprise a microprocessor, controller, PLA, or the like. Similarly, the memory 33 may comprise any type of storage device (e.g., any type of memory). Though the processor 32 and the memory 33 are depicted as separate elements, they may be part of a single machine, which includes a microprocessor (or other type of controller) and a memory. Alternatively, the processor 32 may rely on the memory 33 for all of its memory needs. Still alternatively, the processor 32 may rely on a database (such as database 13) for some or all of its memory needs.

The memory 33 may comprise a tangible computer-readable medium that include software that, when executed by the processor 32 is configured to perform any one, any combination, or all of the functionality described herein. In this regard, any functionality described herein, such as (without limitation) with regard to the spare parts planning system 1, the communication device 8, 9, the agricultural machine 4, tractor 14, combine harvester 15, forage harvester 16, drone 21, vehicle 22, service vehicle 23, or communication device 25, 26 may use the computing functionality described herein, such as the processor 39, the memory 40 and/or the communication interface 41.

Further, the communication interface 34 may be configured to communicate (e.g., wired and/or wirelessly) with one or more electronic devices. As one example, any one, any combination, or all of the following may communicate with one another via its respective communication interface 34: the spare parts planning system 1, the communication device 8, 9, the agricultural machine 4, tractor 14, combine harvester 15, forage harvester 16, drone 21, vehicle 22, service vehicle 23, or communication device 25, 26.

The processor 32 and the memory 33 are merely one example of a computational configuration for the electronic devices discussed herein. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The customer 24 may have the communication device 25, which may comprise a smartphone. Alternatively or additionally, a suitable communication device 26 may be arranged or positioned in the agricultural machine 4, such as in a driver's cab of the agricultural machine 4, for the customer 24. This communication device 26 may be designed as a driver assistance system, such as with a touch screen.

The communication device 25 and/or 26 may be connected to the communication network 10 of the spare parts planning system 1 via a wireless communication link 11 for data transmission of a customer problem 5.

The spare parts supplier 2 and the agricultural machine technician 3 also may each have their own communication device 8 and 9, respectively, which may comprise a tablet and may be connected to the communication network 10 of the spare parts planning system 1 via a wireless communication link 11 for data transmission, so that the spare parts supplier 2 and/or the agricultural machine technician 3 may be used in the repair and/or maintenance of the agricultural machines 4 of the customer 24.

FIG. 1 shows an example of a central warehouse 31 and several warehouses 18, 19, 20 arranged or positioned at a distance from this central warehouse 31. A larger quantity of spare parts 27 may be stored in the central warehouse 31 compared to the warehouses 18, 19, 20, so that the warehouses 18, 19, 20 may typically have a smaller stock of spare parts 28, 29, 30. The central warehouse 31 and/or the warehouses 18, 19, 20 may each be equipped with storage systems comprising fully automated high-bay warehouses (e.g., operated automatically via robots in order to put stock in and/or remove stock from the respective warehouses). The spare parts 27 may form maintenance parts, wear parts and/or repair parts.

The spare parts planning system 1 may be configured to perform automatic planning and coordination of the spare parts 27 directed towards a service order, with this service order being derived from the definition of a customer problem 5. The spare parts planning system 1 may additionally be configured to automatically assemble the spare parts stock 28, 29, 30 stored in the respective warehouse 18, 19, 20 in such a way that this spare parts stock 28, 29, 30 is automatically adapted to the expected parts failure probability. This adaptation may comprise the storage of the spare parts 27 and/or the procurement of the spare parts 27 from the central warehouse 31 to the respective warehouse 18, 19, 20. The expected parts failure probability may relate to the predominant problems of the agricultural machines 4 in the region, thereby counteracting possible downtimes of the agricultural machines 4 with the spare parts stock 28, 29, 30 stored in the respective warehouse 18, 19, 20, so that the maintenance of the efficient and profitable agricultural operation of the customer 24 may be ensured.

The spare parts planning system 1 may be configured to automatically determine the expected parts failure probability as a function of seasonal probability requirements and/or information relating to the agricultural machines 4 and/or location information, so that the spare parts supplier 2 with a vehicle 22 (e.g., a self-driving vehicle) as a spare parts carrier transports a number of spare parts from the central warehouse 31 at the appropriate time and stores them (e.g., automatically stores via robots) in the warehouse 19, since the spare parts stock 29 of the warehouse 19, as exemplified in FIG. 1, in contrast to the other warehouses 18, 20, which may have a low spare parts stock 29 and, due to the expected probability of parts failure in the region of this warehouse 19, a larger spare parts stock 29 is secured in advance. Thus, the spare parts planning system 1 may be configured to optimize the quantity of stored spare parts 27 and/or the procurement of the spare parts 27 in the respective warehouses 18, 19, 20 depending on the expected parts failure probability in such a way that the spare parts 27 reaches each customer 24 as quickly as possible (e.g., the number of spare parts stored in the different respective warehouses 18, 19, 20 may be different based on location of the respective warehouse 18, 19, 20, agricultural machines serviced by the respective warehouse 18, 19, 20, etc.).

The customer problem 5 may have, in addition to information regarding a spare part 27, a delivery position of this spare part 27 desired by the customer 24. This delivery position may be a self-pickup location, such as a warehouse 18, 19, 20, and/or a drop-off position with a delivery location 7 outside the warehouses 18, 19, 20. The vehicle 22 may deliver (e.g., automatically deliver via a self-driving vehicle) the spare part 27 to the self-pickup location formed by the warehouse 19, while an autonomous drone 21 may transport another spare part 27 to the delivery location 7 as a drop-off position and hand it over directly to the customer 24.

The spare parts planning system 1 may be configured to automatically generate an optimal route plan for spare parts carriers (e.g., drone 21, vehicle 22), such as the autonomous spare parts carriers and/or a spare parts supplier 2 to the optimal delivery position (e.g., the self-pickup location and/or the drop-off location) for the coordination of the spare parts 27.

For particularly critical situations of the customer 24, the spare parts planning system 1 may be configured in such a way that this customer 24 may secure the shortest feasible time for the delivery of the spare part 27 to the predetermined delivery position using a digital fee payment. In this regard, an operator of the spare parts scheduling system 1 and/or the customer 24 may use satellite 17 based tracking of the spare parts 27 to automatically verify and/or automatically monitor the delivery location and time.

In addition, the spare parts planning system 1 may be configured to automatically prepare the spare parts stock 28, 29, 30 stored in the respective warehouse 18, 19, 20 in advance for repairs and/or maintenance of the agricultural machines 4 depending on the service order in such a way that the required spare parts 27 and/or tools for the repair and/or maintenance of the agricultural machines 4 may be available at the customer 24 at the latest at the same time as the commissioned agricultural machine technician 3, who travels to the customer 24 with a service vehicle 23 (e.g., via self-driving vehicle). In this case, the distances 6 of the assigned agricultural machine technician 3 and the spare part 27 may be determined using the satellite 17 based position information. This may reduce or minimize the downtime of the agricultural machines 4 and may ensure the efficiency and profitability of the agricultural operation of customer 24.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Spare parts planning system
2 Spare parts supplier
3 Agricultural machine technician
4 Agricultural machine
5 Customer problem, especially purchase order
6 Distance
7 Place of delivery and/or use
8 Communication device
9 Communication device
10 Communications network
11 Wireless or wired communication link
12 Server
13 Database
14 Tractor
15 Self-propelled combine harvester
16 Self-propelled forage harvester
17 Satellite
18 Warehouse
19 Warehouse
20 Warehouse
21 Drone (e.g., autonomous drone) as spare parts carrier
22 Vehicle (e.g., autonomous vehicle) as spare parts carrier
23 Service vehicle
24 Customer (e.g., farmer)
25 Communication device of the farmer
26 Communication device of the agricultural machine
27 Spare part
28 Spare parts stock
29 Spare parts stock
30 Spare parts stock
31 Central warehouse
32 Processor
33 Memory
34 Communication interface

1. A spare parts planning system configured to automatically plan and coordinate spare parts for agricultural machines, the spare parts planning system comprising:
at least one server;
at least one database; and
at least one communication device;
wherein the at least one server, the at least one database, and the at least one communication device are configured to communicate with each other via one or more networks;
wherein the at least one server is configured to:
in advance of receiving a customer problem for a respective agricultural machine:
automatically determine a failure probability for a respective spare part; and
automatically assembling stock of the respective spare part in one or more local warehouses by:
automatically accessing a current stock of the respective spare part in the one or more local warehouses; and
automatically procuring, based on the failure probability for the respective spare part and the current stock of the respective spare part in the one or more local warehouses, the respective spare part from one or more central warehouses for delivery to the one or more local warehouses;
receive the customer problem from the at least one communication device of a customer regarding one or both of repair or maintenance of the respective agricultural machine using the respective spare part;
responsive to receiving the customer problem:
automatically access, from the at least one database, information relating to one or both of location or one or more delivery options of the respective spare part from the one or more local warehouses;
automatically initiate a delivery of the respective spare part from the one or more local warehouses to a delivery location specified by the customer and a technical service for the one or both of the repair or the maintenance of the respective agricultural machine; and
automatically determine a route plan for one or both of a spare parts carrier or a spare parts supplier starting from the one or more local warehouses to the delivery location specified by the customer in order to coordinate delivery of the respective spare part.

2. The spare parts planning system of claim 1, wherein the at least one server is configured to automatically determine the failure probability for the respective spare part by:
automatically access one or both of a location of the respective agricultural machine or information relating to the respective agricultural machine;
automatically determine the failure probability based on seasonal probability requirements of the respective agricultural machine and one or both of the location of the respective agricultural machine or the information relating to the respective agricultural machine.

3. The spare parts planning system of claim 2, wherein the at least one server is configured to automatically determine the failure probability for the respective spare part by:
automatically access both of the location of the respective agricultural machine and the information relating to the respective agricultural machine;
automatically determine the failure probability based on seasonal probability requirements of the respective agricultural machine, the location of the respective agricultural machine, and the information relating to the respective agricultural machine.

4. The spare parts planning system of claim 1, wherein the at least one server is configured to automatically assembling the stock of the respective spare part in the one or more local warehouses so that, responsive to receiving the customer problem, the delivery of the respective spare part from the one or more local warehouses to the delivery position specified by the customer is within a predetermined amount of time.

5. The spare parts planning system of claim 1, wherein the customer problem includes, in addition to information relating to the respective spare part, the delivery location of the spare part desired by the customer.

6. The spare parts planning system of claim 5, wherein the delivery location of the respective spare part desired by the customer comprises a self-pickup location.

7. The spare parts planning system of claim 6, wherein the self-pickup location comprises at least one of the one or more local warehouses; and
wherein, responsive to the self-pickup location comprising the at least one of the one or more local warehouses, the at least one server is configured to automatically determine the route plan for the customer from a respective location of the customer to the at least one of the one or more local warehouses.

8. The spare parts planning system of claim 6, wherein the delivery location of the respective spare part desired by the customer comprises a drop-off position; and
wherein, responsive to the self-pickup location comprising the drop-off position, the at least one server is configured to automatically determine the route plan for the one or both of the spare parts carrier or the spare parts supplier starting from the one or more local warehouses to the self-pickup location specified by the customer.

9. The spare parts planning system of claim 5, wherein the customer problem includes a delivery time at which the delivery of the respective spare part at the delivery position is defined by the customer; and
wherein the at least one server is configured to automatically initiate the delivery of the respective spare part and automatically determine the route plan so that the respective spare part is delivered, at the delivery position, at the delivery time.

10. The spare parts planning system of claim 1, wherein the route plan comprises an optimal route plan; and
wherein the at least one server is configured to automatically determine the optimal route plan by:
automatically accessing road closures; and
automatically determining the optimal route plan by avoiding the road closures.

11. The spare parts planning system of claim 1, wherein the at least one server is configured to automatically assemble the stock of the respective spare part in one or more local warehouses by:
automatically determining a required time period for storage of the respective spare part in the one or more local warehouses; and
automatically procuring, based on the failure probability for the respective spare part, the current stock of the respective spare part in the one or more local warehouses and the required time period for storage of the respective spare part in the one or more local warehouses, the respective spare part from one or more central warehouses for delivery to the one or more local warehouses.

12. The spare parts planning system of claim 1, wherein the at least one server is further configured to automatically determine a required time period for performing the delivery of the respective spare part at the delivery position; and
wherein, responsive to automatically determining the required time period, the at least one server is configured to automatically determine when to initiate the delivery of the respective spare part and automatically determine the route plan.

13. The spare parts planning system of claim 1, wherein the at least one server is further configured to receive a fee payment from the customer; and
wherein, responsive to receiving the fee payment, the at least one server is configured to automatically determine when to initiate the delivery of the respective spare part or how to automatically deliver the respective part in order to more quickly deliver the respective spare part.

14. The spare parts planning system of claim 1, wherein the at least one server is configured to automatically determine the failure probability for the respective spare part at a defined future point in time; and
wherein, responsive to determining the defined future point in time, the at least one server is configured to automatically optimize one or more of:
storage of the respective spare part in the one or more local warehouses;
procurement of the respective spare part from the central warehouse; or
the delivery of the respective spare part to the delivery position.

15. The spare parts planning system of claim 14, wherein the at least one server is configured to automatically determine the failure probability for the respective spare part at the defined future points in time for a plurality of customers; and
wherein, responsive to determining the defined future points in time, the at least one server is configured automatically optimize each more of:
storage of the respective spare parts in the one or more local warehouses;
procurement of the respective spare parts from the central warehouse; or
the delivery of the respective spare parts to the delivery positions for the plurality of customers.

16. The spare parts planning system of claim 1, wherein the at least one server is further configured to, responsive to a request from one or both of the customer or an operator of the spare parts planning system, track a current location of the respective spare part in each of the central warehouse, the one or more warehouses, and on the delivery of the respective spare part from the one or more local warehouses to the delivery position.

17. The spare parts planning system of claim 1, wherein the at least one server is further configured to receive an indication of a time when an agricultural machine technician will arrive at a place of use of the respective agricultural machine; and
wherein, responsive to receiving the indication of the time when an agricultural machine technician will arrive at a place of use of the respective agricultural machine, the at least one server is configured to perform one or more of the following so that the respective part is at the place of use at least prior to the time when the agricultural machine technician will arrive at the place of use:
automatically assemble the stock of the respective spare part in the one or more local warehouses;
automatically initiate the delivery of the respective spare part; or
automatically determine the route plan.

18. The spare parts planning system of claim 17, wherein the at least one server is further configured to receive an indication of a time when an agricultural machine technician will arrive at a place of use of the respective agricultural machine; and
wherein, responsive to receiving the indication of the time when an agricultural machine technician will arrive at a place of use of the respective agricultural machine, the at least one server is configured to perform each of the following so that the respective part is at the place of use at least prior to the time when the agricultural machine technician will arrive at the place of use:
automatically assemble the stock of the respective spare part in the one or more local warehouses;
automatically initiate the delivery of the respective spare part; and
automatically determine the route plan.

19. The spare parts planning system of claim 1, wherein the at least one server is further configured to receive an indication of a time when an agricultural machine technician will arrive at a place of use of the respective agricultural machine;
wherein the at least one communication device is automatically configured to transmit a respective current position to one or both of the at least one server or the at least one database; and
wherein the at least one server is configured to automatically coordinate the one or both of the repair or the maintenance of the respective agricultural machine so that one or both of the respective spare part or one or more tools for the repair or the maintenance of the respective agricultural machine are at the place of use at least prior to the time when the agricultural machine technician will arrive at the place of use.
